(19) United States
(12) Patent Application Publication
(10) Pub. No.: US 2025/0336105 A1
(43) Pub. Date: Oct. 30, 2025

(54) GENERATION SUPPORT DEVICE, GENERATION SUPPORT PROGRAM, AND GENERATION SUPPORT METHOD

(71) Applicant: FOTOGRAPHER AI, INC., Tokyo (JP)

(72) Inventors: Rintaro SUZUKI, Tokyo (JP); Ibrahima KANE, Tokyo (JP); Saliou KANE, Tokyo (JP)

(21) Appl. No.: 19/264,887

(22) Filed: Jul. 10, 2025

Related U.S. Application Data
(63) Continuation of application No. PCT/JP2024/022627, filed on Jun. 21, 2024.

(30) Foreign Application Priority Data
Aug. 10, 2023 (JP) 2023-131665

(51) Int. Cl. G06T 11/00

(52) U.S. Cl. CPC G06T 11/00

(57) ABSTRACT

Provided is a generation support device for supporting generation of a result image. The generation support device includes: a generation information acquisition unit configured to acquire, from a user, generation information including at least style information regarding a style of the result image and an element image constituting part of the result image; and a result image generation unit configured to input text information generated based on the generation information into a generative model, and generate the result image based on output information output from the generative model.

### FIELD

The present invention relates to a generation support device, a generation support program, and a generation support method.

### BACKGROUND

In recent years, images are generated by various methods.

### CITATION LIST

### Patent Literature

Patent Literature 1: Japanese Patent No. 7169027

### SUMMARY

### Technical Problem

For example, Patent Literature 1 proposes a technology for generating character images using machine learning.

However, the technology in Patent Literature 1 is limited to generating images of characters in arbitrary postures, and it is not applicable to generation of various images.

The present invention is designed in view of the aforementioned circumstances, and it is an object thereof to allow users to easily generate target images.

### Solution to Problem

In order to overcome such issues, a generation support device according to the present disclosure includes: a generation information acquisition unit configured to acquire, from a user, generation information including at least style information regarding a style of a result image and an element image constituting part of the result image; and a result image generation unit configured to input text information generated based on the generation information into a generative model, and generate the result image based on output information output from the generative model.

Other issues and solutions thereof disclosed in the present application will become evident in the “Description of Embodiments” section and in the drawings.

### Advantageous Effects of Invention

The present invention enables users to easily generate the target images.

### BRIEF DESCRIPTION OF DRAWINGS

FIG. 1 is a diagram illustrating an example of an overall configuration of an evaluation system according to an embodiment of the present invention.

FIG. 2 is a diagram illustrating an example of a hardware configuration of a server apparatus 1 according to the present embodiment.

FIG. 3 is a diagram illustrating an example of a functional configuration of the server apparatus 1 according to the present embodiment.

FIG. 4 is a diagram illustrating an example of basic information stored in a generation information storage unit 131.

FIG. 5 is an example of a screen where a generation information acquisition unit 111 acquires position information of partial images and material images.

FIG. 6 is a diagram illustrating an example of processing of the server apparatus 1 according to the present embodiment.

### DESCRIPTION OF EMBODIMENTS

### Summary of Invention

### Item 1

A generation support device for supporting generation of a result image, the generation support device including:

a generation information acquisition unit configured to acquire, from a user, generation information including at least style information regarding a style of the result image and an element image constituting part of the result image; and

a result image generation unit configured to input text information generated based on the generation information into a generative model, and generate the result image based on output information output from the generative model.

### Item 2

The generation support device according to item 1, in which the generation information acquisition unit further acquires position information of the element image in the result image.

### Item 3

The generation support device according to item 1 or 2, in which

the style information includes information of a web address, and

the generation information acquisition unit takes, as the style information, the style information that is determined based on web information included in a website designated by the web address.

### Item 4

The generation support device according to item 2, in which the information acquisition unit accepts upload or selection of the element image, and acquires the position information based on layout of the element image in a frame of the result image.

### Item 5

The generation support device according to item 1 or 2, in which the information acquisition unit acquires the generation information by input made by the user in a chat format.

### Item 6

The generation support device according to item 5, in which, when acquiring input in the chat format, the information acquisition unit presents a suggestion of information required as the generation information to the user.

### Item 7

A generation support program for supporting generation of a result image, the generation support program causing a processor to execute:

a generation information acquisition step of acquiring, from a user, generation information including at least style information regarding a style of the result image and an element image constituting part of the result image; and

an image generation step of inputting text information generated based on the generation information into a generative model, and generating the result image based on output information output from the generative model.

### Item 8

A generation support method for supporting generation of a result image, the generation support method including causing a processor to execute:

a generation information acquisition step of acquiring, from a user, generation information including at least style information regarding a style of the result image and an element image constituting part of the result image; and

an image generation step of inputting text information generated based on the generation information into a generative model, and generating the result image based on output information output from the generative model.

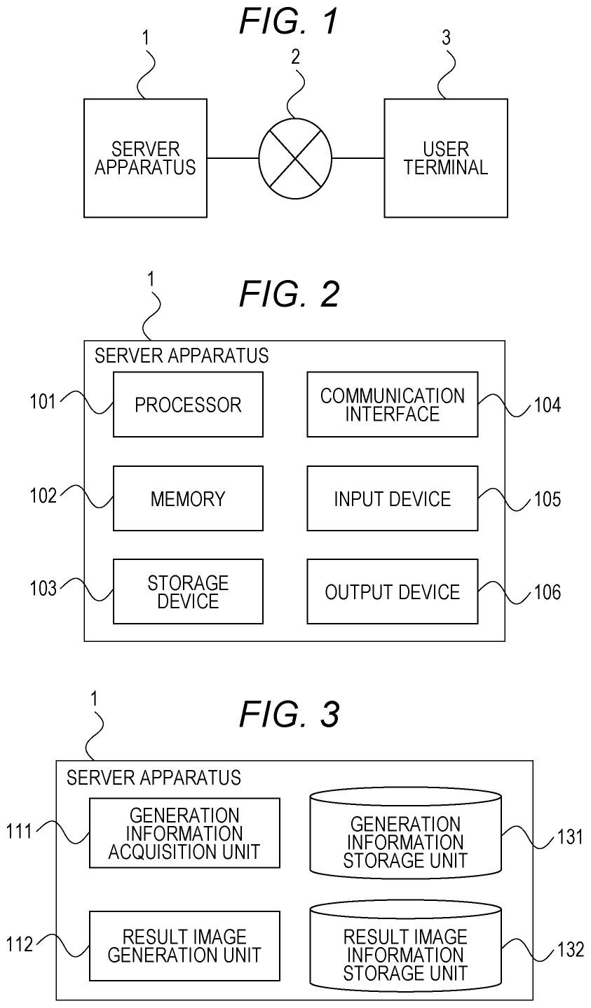

FIG. 1 is a diagram illustrating an example of the overall configuration of an evaluation system according to an embodiment of the present invention. The generation support system according to the present embodiment is configured including a server apparatus 1. The server apparatus 1 is communicatively connected to a user terminal 3 via a communication network 2. The communication network 2 is the Internet, for example, and is constructed by a public telephone network, a mobile phone network, a wireless communication channel, Ethernet (registered trademark), or the like.

### Server Apparatus 1

he server apparatus 1 may be a general-purpose computer such as a workstation or personal computer, for example, or it may be logically realized by cloud computing. While a single unit is illustrated in the present embodiment for convenience of explanation, the number thereof is not limited thereto and there may also be a plurality of units.

### User Terminal 3

The user terminal 3 is a computer that is handled by a user who generates images. Examples thereof may be a smartphone, a tablet computer, and a personal computer. The user can access the server apparatus 1 through an application or a web browser executed in the user terminal 3, for example.

FIG. 2 is a diagram illustrating an example of a hardware configuration of the server apparatus 1. Note that configuration illustrated in the drawing is an example, and other configurations may be employed as well. The server apparatus 1 includes a processor 101, a memory 102, a storage device 103, a communication interface 104, an input device 105, and an output device 106. The storage device 103 is, for example, a hard disk drive, a solid state drive, or a flash memory, which stores various kinds of data and programs. The communication interface 104 is an interface for connecting to the communication network 2, and examples thereof may be an adapter for connecting to the Ethernet (registered trademark), a modem for connecting to a public telephone network, a wireless communication device for enabling wireless communication, and a Universal Serial Bus (USB) connector as well as an RS232C connector for serial communication. The input device 105 is, for example, a keyboard, a mouse, a touch panel, buttons, and a microphone for inputting data. The output device 106 is, for example, a display, a printer, or a speaker for outputting data. Note that each functional unit of the server apparatus 1 to be described later is realized by the processor 101 reading out a program stored in the storage device 103 onto the memory 102 and executing it, and each storage unit of the server apparatus 1 is realized as part of the memory area provided by the memory 102 and storage device 103.

FIG. 3 illustrates the functional configuration of the server apparatus 1. As illustrated in FIG. 3, the server apparatus 1 includes each of storage units that are a generation information storage unit 131 and a result image information storage unit 132, as well as each of processing units that are a generation information acquisition unit 111 and a result image generation unit 112.

Each of the storage units that are the generation Information storage unit 131 and the result Image information storage unit 132 will be described.

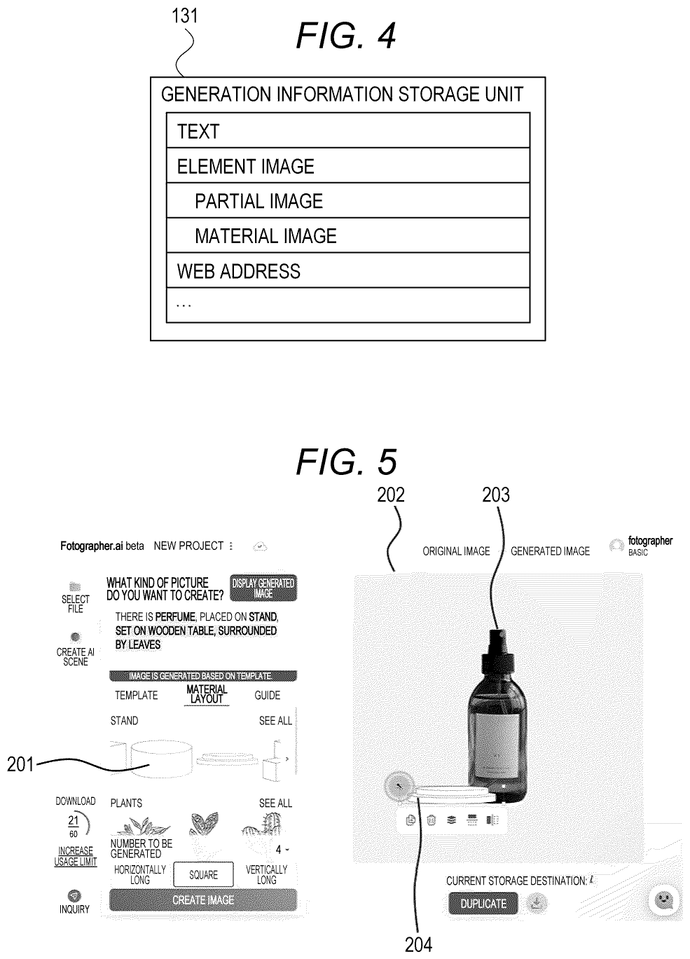

The generation information storage unit 131 stores information (referred to as generation information hereinafter) used to generate a result image (image generated by the server apparatus 1), as illustrated in FIG. 4 as an example. Generation information may include, as an example, information such as the information regarding the style (including text information, web address, web information, and the like). The generation information may also include element images that are the basis for the configuration of part of the result image. An element image is a partial image that is, for example, an image of the subject of the result image (for example, a person or object, which is the target that is to be described as the main content of the image when the generation information acquisition unit 111 described later generates the text to be input into a generative model). The partial image, when the subject of the image is an object, may include an image of a product, an image containing the product, and an image of external appearances such as the container of the product, outer box, and the like, for example. The element image may also include a material image that is not the subject of the result image. Generation information may include, but is not limited to, for example, information on the positions of partial images and material images in the result image.

The style refers to the style in the design of the result image generated by the generation support device, and represents, but is not limited to, for example, requirements for the result image (for example, elements such as object, person, and scenery included in the image), concept (target, narrative, and the like), as well as aesthetic attributes and characteristics such as color, texture (for example, texture on the image surface that is perceived by the visual sense), layout (for example, layout and relative positional relationship of the elements), font, and shape (for example, sharp angle, rounded shape, straight lines, curves, and the like).

The material images are images to be the basis for part of the result image, such as images of hand, face, plant, everyday item, and stand, geometric shapes such as circle, triangle, and square or free-form shapes that are not bound by geometric rules. The material image may also include, but is not limited to, an image (template) that serves as the basis for the background of the image to be generated.

The result image information storage unit 132 stores the result images generated by the result image generation unit 112.

Hereinafter, each of the processing units that are the generation information acquisition unit 111 and the result image generation unit 112 will be described.

The generation information acquisition unit 111 acquires, as an example, generation information that is necessary for generating the result image, which includes style information regarding the style of the result image, an element image constituting the result image, and position information of the element images in the result image from the user terminal 3 via the communication network 2. The generation information acquisition unit 111 stores the acquired generation information in the generation information storage unit 131. The communication in such transmission and reception may be either wired or wireless communication, and any communication protocol may be used as long as it enables mutual communication.

The generation information acquisition unit 111 may acquire the generation information by text information. The generation information acquisition unit 111 may acquire a sentence indicating the result image to be generated by an input operation of the user, or it may acquire one or more words. The generation information acquisition unit 111 may also present sentences or words that represent the style of the result image to be generated to the user, and acquire the sentence or word selected by the user as the generation information.

The generation information acquisition unit 111 may acquire information of the web address (URL or the like) as the generation information. The generation information acquisition unit 111 can acquire the web information included in the website designated by the web address, determine the style, and use it as the generation information. Web information may be text information, image information, video information, code information (code that configures the website, such as, but is not limited to, format of HTML, CSS, or JavaScript) and the like included in the website. The generation information acquisition unit 111 may determine the style such as the target and concept based on such text information, for example. In this case, the generation information acquisition unit 111 may perform morphological analysis on such text information, for example, and determine the style such as the target and concept based on the information of the words included therein and the number thereof. However, the methods are not limited thereto. The generation information acquisition unit 111 may determine the style such as the color, texture, font, and shape from the image information, video information, code information, and the like. In this case, the generation information acquisition unit 111 may analyze the image information and video information and determine the style based on the most common color, texture, font, shape, and the like that are included therein, or may determine the style based on the information of the colors, textures, shapes, fonts, and the like used on the web background image included in the code information. However, the methods are not limited thereto.

The generation information acquisition unit 111 acquires an element image that is the basis for the configuration of part of the result image. The generation information acquisition unit 111 may accept upload of the element image. Furthermore, as illustrated as an example in FIG. 5, for example, the generation information acquisition unit 111 may store material images (for example, 201 in FIG. 5) in the server apparatus 1 and present those to the user terminal 3, accept a selection operation of the material image from the user, and acquire the material image selected by the user as the generation information.

As an example, the generation information acquisition unit 111 acquires the position information of the element image in the result image. The position information indicates the coordinates of the element image in the result image. For example, the coordinates may be XY coordinates with the origin at a prescribed position such as a specific corner of the result image, and may be the XY coordinates of the center or the like of the element image. In this case, as illustrated as an example in FIG. 5, for example, the generation information acquisition unit 111 presents, to the user terminal 3, a frame corresponding to the shape of the result image (an example thereof may be 202. The frame may be, but is not limited to, in a form of horizontally-long shape, square, vertically-long shape, or the like). The generation information acquisition unit 111 acquires information of the operation of the user made on the user terminal 3 in the frame, and acquires position information of the material image in the result image. In this case, the generation information acquisition unit 111 may, for example, accept a drag-and-drop operation by the user, acquire layout information of the partial image (203) or the material image (204), and acquire position information of the element image. The generation information acquisition unit 111 may also accept enlargement, reduction, rotation, flipping, transformation, and the like of the element image. Furthermore, the generation information acquisition unit 111 may acquire the front-rear relationship of a plurality of element images (may be layer information, for example) as the position information. In addition, position information may be information of the positional relationship between element images (the material image is at the bottom of the partial image, or the like).

The generation information acquisition unit 111 may acquire the generation information in a chat format. In this case, the generation information acquisition unit 111 may divide the text information acquired in a chat format into words by morphological analysis or the like, and acquire the information of the words as the generation information. In this case, the generation information acquisition unit 111 may support the user to easily recognize the necessary generation information by providing the user with a guide such as “Please upload an image of the subject” or “Please indicate reference websites” regarding the generation information to be acquired from the user. In this case, the generation information acquisition unit 111 may present a guidance to the user from a previously prepared list of generation information necessary for generating an image, regarding information that is not acquired from the user or information that is not possible to be determined from the acquired generation information. However, the methods are not limited thereto.

The generation information acquisition unit 111 generates a prompt, a prerequisite condition, or the like (collectively referred to as prompt information herein) to be input into an image generative model based on the acquired generation information. The prerequisite condition may include, but is not limited to, information such as image size, frame shape, file size, resolution, and the like. The prompt generated by the generation information acquisition unit 111 includes at least text representing the style. The generation information acquisition unit 111 uses a feature extraction module and a language model, for example, to generate prompt information. Note that the generation information acquisition unit 111 may generate one or more pieces of prompt information, present them to the user, and accept selection or editing of the prompts.

When generating the prompts, the generation information acquisition unit 111 may change the structure of the prompts to be generated depending on the type of generative model used by the result image generation unit 112 for generating images. The generation information acquisition unit 111 may generate a sentence-type prompt or a prompt in the form of a list of words, for example. In addition, the prompt may also be generated in a form that allows the generative model side to recognize important words using the methods for indicating the importance of the words, such as by enclosing important words in parentheses, by having the order of words presented at the beginning of the prompt, or by including a plurality of important words.

The prompt generated by the generation information acquisition unit 111 includes at least text representing the style. The generation information acquisition unit 111 may also generate a plurality of prompts or may give a certain randomness in the text included in the prompts. For example, the generation information acquisition unit 111 gives a certain randomness in the text included in the prompts by the distance, similarity, and the like in the meaning with that of the text representing the style. Specifically, when the generation information acquired by input or the like of the user includes a plurality of pieces of information of the style related to “sea”, for example, the generation information acquisition unit 111 generates prompts by including other words that are close in the meaning of “sea” or that are highly similar in the prompts. The result image generation unit 112 described later can generate a result image that is closer to the image the user desires to generate, by generating the result image using those prompts. Conversely, when the generation information acquired by input or the like of the user includes little information of the style related to “sea”, the generation information acquisition unit 111 generates prompts by including other words that are distant in the meaning of “sea” or that are less similar in the prompts. In a case where the user does not yet have an image of the sea, for example, the result image generation unit 112 to be described later makes it possible to easily consider the direction of the style of the result image by generating the result image using those prompts. Note that there may also be other effects of giving a certain randomness in the text included in the prompts.

The generation information acquisition unit 111 may additionally acquire generation information for a first result image generated by the result image generation unit 112. The generation information additionally acquired by the generation information acquisition unit 111 is used for modifications, additions, and the like for the prompt that is used when generating the first result image, and it is used by the result image generation unit 112 to generate a second result image.

The result image generation unit 112 generates, as an example, a result image based on at least one of the style information, element image, and position information. The result image generation unit 112 inputs, for example, prompt information generated by the generation information acquisition unit 111 based on at least one of the style information, element image, and position information into the generative model, and acquires an image output from the generative model. The result image generation unit 112 may use the image output from the generative model as a result image, or it may perform editing or the like on the output image to generate a result image. The result image generation unit 112 presents the generated result image to the user. The user can download the presented image.

The generative model used by the result image generation unit 112 to generate the result image may be, but not limited to, implemented on the server apparatus 1 or on other servers that are accessible through the communication network 2. Therefore, when the generative model is implemented on the server apparatus 1, the result image generation unit 112 inputs the prompt information to the generative model. When the generative model is implemented on another server, the result image generation unit 112 transmits the prompt information to the generative model via the communication network 2. It is expressed herein that the prompt information is input to the generative model, including the case where the prompt information is transmitted to the generative model.

The generative model may only need to be, for example, a model that receives a specific input vector and random noise given as input and generates an image from such information. The generative model includes, for example, a generator. The generator converts the input information into an appropriate feature or pattern, and converts it into an image. The generator is built using, for example, Convolutional Neural Network (CNN), Transformer, or other deep learning architectures, while other architectures can also be used. The generative model also includes, for example, a discriminator. The discriminator identifies whether the image is a real image or a fake image that is generated by the generator. The identifier is built using a network such as, but is not limited to, CNN. The generative model includes, for example, an adversarial network (GAN). The adversarial network is trained to allow the generator to generate more realistic images, and at the same time to increase the ability of the discriminator to distinguish between real and fake images.

The result image generation unit 112 may generate two or more result images. The result image generation unit 112 also presents the generated result image to the user.

Upon presenting a plurality of generated result images to the user terminal 3, the result image generation unit 112 may accept a selection operation from the user on the user terminal 3 to select an image that is close to or deviated from the result image desired to be generated from those images, and further generate a result image based on the result image selected by the selection operation. In such a case, the result image generation unit 112 may generate a result image B similar to a result image A based on the features of the result image A that is selected from the images as an image similar to the result image desired to be generated, for example. As specific processing, although not limited to this method, the generation information acquisition unit 111 may modify the prompt information input into the generative model when generating the result image A selected by the selection operation or generate prompts indicating re-generation of images or variations similar to the selected result image A, and generate a result image by inputting those prompts again into the generative model.

The result image generation unit 112 may generate a second result image, when the generation information acquisition unit 111 acquires additional information from the user for the generated result image (first result image). In this case, the result image generation unit 112 may input, to the generative model, the prompt information that is input to the generative model when generating the first result image and prompt information generated by the generation information acquisition unit 111 based on the additional information, and generate a second result image based on output information output from the generative model.

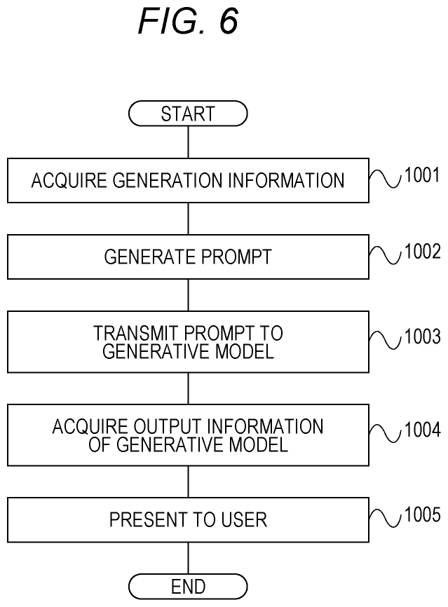

FIG. 6 is a diagram for describing an example of processing of the generation support device according to the present embodiment.

The server apparatus 1 acquires generation information from the user (1001). The server apparatus 1 generates a prompt based on the acquired generation information (1002). The server apparatus 1 inputs the prompt into the generative model (1003). The server apparatus 1 acquires output information (result image) of the generated model (1004). The server apparatus 1 presents the output information to the user (1005).

Other examples will be described below.

The server apparatus 1 may perform, for example, preprocessing of a partial image acquired by the generation information acquisition unit 111. The server apparatus 1 may determine the subject of the partial image, for example, and remove the background except for the subject part. The generation information acquisition unit 111 may also highlight the subject from the partial image, for example.

The server apparatus 1 may, as the preprocessing, for example, detect the camera angle by determining the relationship between the subject and the camera position in regard to the subject included in the partial image, and generate a prompt by the generation information acquisition unit 111 accordingly. Such a prompt includes, but is not limited to, the prompt that designates the angle at which the subject is to be displayed in the result image, for example.

Note that the generation information acquisition unit 111 may acquire the position information regarding the above-described preprocessed partial image in the image to be generated, or may generate a prompt.

The server apparatus 1 may also suggest the style to the user based on marketing information. Such marketing information may include information acquired in advance, such as information of the product or the like to be the subject of a result image, information on the industry, information such as the results of marketing surveys or the like, as well as information acquired from the user, such as past product sales performance of the product to be the subject, sales of similar products, and the like. Regarding the product as the subject of the image to be generated, for example, the server apparatus 1 suggests, to the user, the style that is determined from the sales websites, advertising images, and the like of similar products with a large number of sales based on the information of the sales performance and the like of the similar products. In this case, the server apparatus 1 may present, to the user, the information of the web addresses of the websites selling similar products with a large number of sales, text information (for example, “luxury”, “natural”, and the like) to be included in the prompt generated by the generation information acquisition unit 111 as the style, or may include such information in the prompt used for generating the image.

The server apparatus 1 may recommend the style to the user based on the result images generated by the user using the server apparatus 1 in the past or the information of the prompts used when generating the result images. For example, the server apparatus 1 may analyze the result images generated by the user in the past, or determine the styles using the information of the text included in the prompts, present the most frequently detected style to the user terminal 3, and acquire an operation to select whether to use that style for generating a result image. Specifically, when determined that the user has only generated realistic images in the past, for example, the server apparatus 1 may present, to the user terminal 3, questions via chat such as “Do you want to generate a realistic image? Yes or No” to acquire a selection operation from the user, and generate a prompt based on the answer selected by the user.

The server apparatus 1 may generate not only images but also information regarding product sales. Although not limited thereto, the information generated by the server apparatus 1 includes, for example, images for banner advertisements that promote products, campaigns, and the like, effective catchphrases and taglines that succinctly express the features of the products and brands, product descriptions that are text information describing detailed descriptions and characteristics of the products, design and layout used for the top pages or the like of e-commerce sites selling the products, category page design that is the design and display method of product category pages, design of landing pages for emphasizing specific campaigns and products, images, catchphrases, and the like for social media and advertising platforms. When generating the information described above, the server apparatus 1 may generate a prompt based on the information acquired by the generation information acquisition unit 111, and the result image generation unit 112 may input the prompt into an image generative model in a case of image or design, while inputting the prompt into a text generative model (for example, a large language model such as ChatGPT) in a case of text information.

When acquiring an element image constituting part of the result image, the server apparatus 1 may acquire, as the elemental image, an image included in a website specified by a designated web address. The server apparatus 1 may acquire all images included in the website as element images and store them in the generation information storage unit 121, or it may accept a selection operation from the user for the images to be acquired as generation information from among the images included in the website and store the selected images as the element images.

While the preferred embodiment of the present disclosure is described above in detail by referring to the accompanying drawings, the technical scope of the present disclosure is not limited to such examples. Various modifications and alterations will become apparent to those skilled in the art of the present disclosure without departing from the scope and technical spirit of the appended claims, and it is to be understood that those also naturally fall within the technical scope of the present disclosure.

The devices described herein may be realized as standalone devices or may be realized as a plurality of devices (for example, cloud servers), some of or all of which are connected via the communication network 2. For example, the processor 101 and the storage device 103 of the server apparatus 1 may be realized by different servers connected to each other via the communication network 2.

The series of processing executed by the devices described herein may be realized using software, hardware, and a combination of software and hardware. It is possible to create a computer program for realizing each function of the server apparatus 1 according to the present embodiment, and implement it on a PC or the like. It is also possible to provide a computer-readable recording medium with such a computer program stored therein. Examples of the recording media um may be a magnetic disk, an optical disk, a magneto-optical disk, and a flash memory. The computer program described above may also be distributed via the communication network 2, for example, without using a recording medium.

Furthermore, the processing described herein do not necessarily need to be executed in the described order. Some processing steps may also be executed in parallel. Additional processing steps may also be employed, and some processing steps may be omitted as well.

The effects described herein are descriptive or illustrative purpose only, and not intended to be limited thereto. In other words, the technology according to the present disclosure can produce other effects that are apparent to those skilled in the art from the description herein, along with or in place of the effects described above.

### Reference Signs List

1 Server apparatus
2 Communication network
3 User terminal
101 CPU
102 Memory
103 Storage device
104 Communication interface
105 Input device
106 Output device
111 Generation information acquisition unit
112 Result image generation unit
131 Generation information storage unit
132 Result image information storage unit

1. A generation support device for supporting generation of a result image, the generation support device comprising:
a generation information acquisition unit configured to acquires, from a user, generation information including at least style information regarding a style of the result image and an element image constituting part of the result image; and
a result image generation unit configured to input text information generated based on the generation information into a generative model, and generate the result image based on output information output from the generative model.

2. The generation support device according to claim 1, wherein the generation information acquisition unit further acquires position information of the element image in the result image.

3. The generation support device according to claim 1, wherein
the style information includes information of a web address, and
the generation information acquisition unit takes, as the style information, the style information that is determined based on web information included in a website designated by the web address.

4. The generation support device according to claim 2, wherein the information acquisition unit accepts upload or selection of the element image, and acquires the position information based on layout of the element image in a frame of the result image.

5. The generation support device according to claim 1, wherein the information acquisition unit acquires the generation information by input made by the user in a chat format.

6. The generation support device according to claim 5, wherein, when acquiring input in the chat format, the information acquisition unit presents a suggestion of information required as the generation information to the user.

7. A generation support program for supporting generation of a result image, the generation support program causing a processor to execute:
a generation information acquisition step of acquiring, from a user, generation information including at least style information regarding a style of the result image and an element image constituting part of the result image; and
an image generation step of inputting text information generated based on the generation information into a generative model, and generating the result image based on output information output from the generative model.

8. A generation support method for supporting generation of a result image, the generation support method comprising causing a processor to execute:
a generation information acquisition step of acquiring, from a user, generation information including at least style information regarding a style of the result image and an element image constituting part of the result image; and
an image generation step of inputting text information generated based on the generation information into a generative model, and generating the result image based on output information output from the generative model.
